(19) United States
(12) Patent Application Publication
(10) Pub. No.: US 2026/0195767 A1
(43) Pub. Date: Jul. 9, 2026

(54) SYSTEMS AND METHODS OF FACILITATING PROVISIONING OF AN AID CORRESPONDING TO A GRIEVANCE OF A USER

(71) Applicant: Vele Veljanovski, Gahanna, OH (US)

(72) Inventor: Vele Veljanovski, Gahanna, OH (US)

(21) Appl. No.: 19/391,780

(22) Filed: Nov. 17, 2025

Related U.S. Application Data
(63) Continuation-in-part of application No. PCT/US25/10353, filed on Jan. 4, 2025.

(51) Int. Cl. G06Q 30/016

(52) U.S. Cl. CPC G06Q 30/016

(57) ABSTRACT

The present disclosure provides a computer-implemented method of facilitating provisioning of an aid of a user. Further, the method may include receiving a user feedback data generated by a user. Further, the user feedback data may be associated with one or more of a service and a product provided by an entity. Further, the method may include analyzing the user feedback data. Further, the method may include determining an indication of a grievance feedback data based on a criterion of the user associated with one or more of the service and the product. Further, the method may include transmitting a communication data to a user device associated with the user and an advisor device associated with an advisor. Further, the advisor may be capable of provisioning an advisory service. Further, the advisory service may be associated with resolution of the grievance.

### FIELD OF DISCLOSURE

Generally, the present disclosure relates to the field of data processing. More specifically, the present disclosure relates to methods, systems, apparatuses and devices for facilitating provisioning of an aid corresponding to a grievance of a user.

### BACKGROUND

There are several instances where users face difficulties with a product and/or a service from an entity. For example, the user may be provided with a bad product or a bad service by the entity. Further, the entity may refuse to provide a better product or service based on a grievance expressed by the user with the product and/or service. In such instances, most users are unable to pursue the grievance further because of lack of competency and/or lack of knowledge of a redressal process associated with the grievance and/or lack of knowledge of suitable personnel who may be competent to help the user.

In the same context, several competent personnel, such as, but not limited to, advisors, adjustors and engineers, are under-utilized because these personnel need to manually search for users who have expressed grievances and approach these users to offer their expertise in resolving the grievances.

In existing technologies, such competent personnel are required to run several queries on various platforms such as social media platforms, search engines, forums etc. and manually review the content to identify users with grievances. This imposes a lot of computational burden on the systems providing these platforms because of the inefficiencies involved in the manual searching process.

Therefore, there is a need for systems and methods of facilitating provisioning of an aid corresponding to a grievance of a user that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a computer-implemented method of facilitating provisioning of an aid corresponding to a grievance of a user. Further, the method may include receiving, using a communication device, a user feedback data generated by a user. Further, the user feedback data may be associated with one or more of a service and a product provided by an entity to the user. Further, the method may include analyzing, using a processing device, the user feedback data. Further, the method may include determining, using the processing device, an indication of a grievance feedback data corresponding to the user feedback data based on a criterion associated with the grievance of the user associated with one or more of the service and the product. Further, the method may include transmitting, using the communication device, a communication data to one or more of a user device associated with the user and an advisor device associated with an advisor. Further, the communication data may be configured to facilitate communication between the user device and the advisor device. Further, the advisor may be capable of provisioning an advisory service to the user. Further, the advisory service may be associated with a resolution of the grievance.

The present disclosure provides a system for facilitating provisioning of an aid corresponding to a grievance of a user. Further, the system may include a communication device. Further, the communication device may be configured to receive a user feedback data generated by the user. Further, the user feedback data may be associated with one or more of a service and a product provided by an entity. Further, the communication device may be configured to transmit a communication data to one or more of a user device associated with the user and an advisor device associated with an advisor. Further, the communication data may be configured to facilitate communication between the user device and the advisor device. Further, the advisor may be capable of provisioning an advisory service to the user. Further, the advisory service may be associated with a resolution of the grievance. Further, the system may include a processing device communicatively coupled with the communication device. Further, the processing device may be configured to analyze the user feedback data. Further, the processing device may be configured to determine an indication of a grievance feedback data corresponding to the user feedback data based on a criterion associated with the grievance of the user associated with one or more of the service and the product. Further, the transmitting may be based on determination of the indication of the grievance feedback data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating provisioning of an aid corresponding to a grievance of a user, in accordance with some embodiments.

FIG. 4 illustrates a flowchart of a method 400 of facilitating provisioning of an aid corresponding to a grievance of a user including generating, using the processing device 604, a search command to the information provider system, in accordance with some embodiments.

FIG. 5 illustrates a flowchart of a method 500 of facilitating provisioning of an aid corresponding to a grievance of a user including generating, using the processing device 604, a recommended grievance resolution plan data, in accordance with some embodiments.

FIG. 6 illustrates a block diagram of the system 600 of facilitating provisioning of an aid corresponding to a grievance of a user, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes systems and method of facilitating provisioning of an aid corresponding to a grievance of a user. Accordingly, in some embodiments, the present disclosure includes the provisioning of a software to identify denied or underpaid insurance claims. Further, the software may be configured to scan the internet for data (such as negative reviews, posts, etc.) related to people dissatisfied with insurance companies, and then may direct the dissatisfied people to resources to help overturn those denials.

Further, the software may assign users to private adjusters and/or engineers for resolution of the grievance of the users as insurance companies denies and/or underpays claims (such as roofs, cars, storm related damages), which accounts for 90% of insurance fraud committed by the insurance companies as every insurance company has to deny 10% of claims to be profitable. Further, the software may gather data by scanning the internet and may direct the users accordingly.

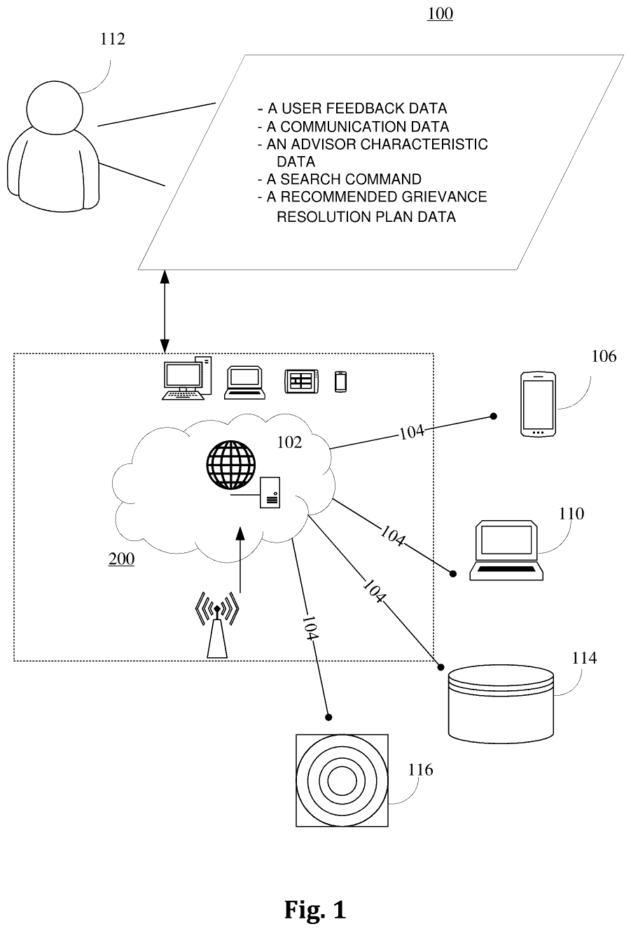

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

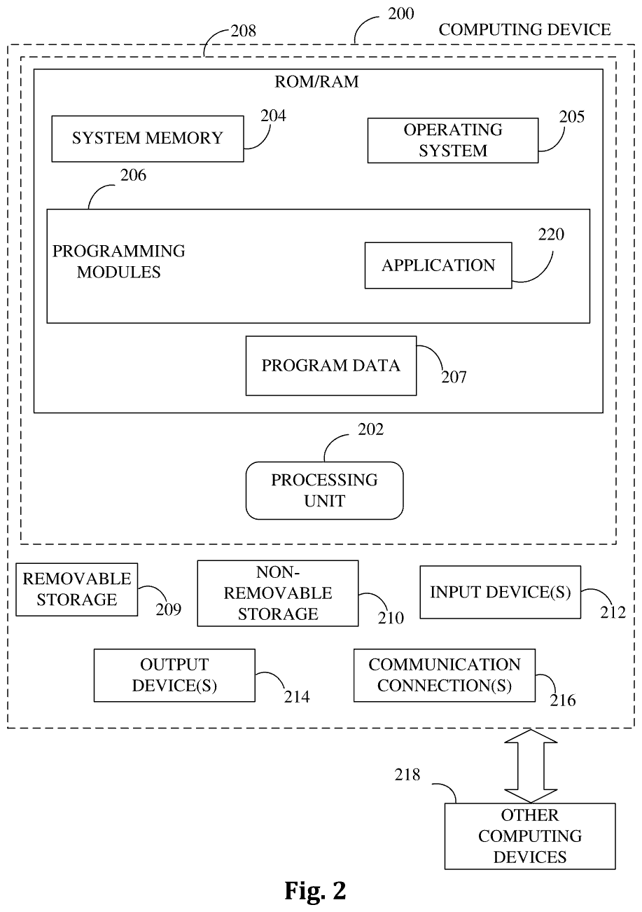

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

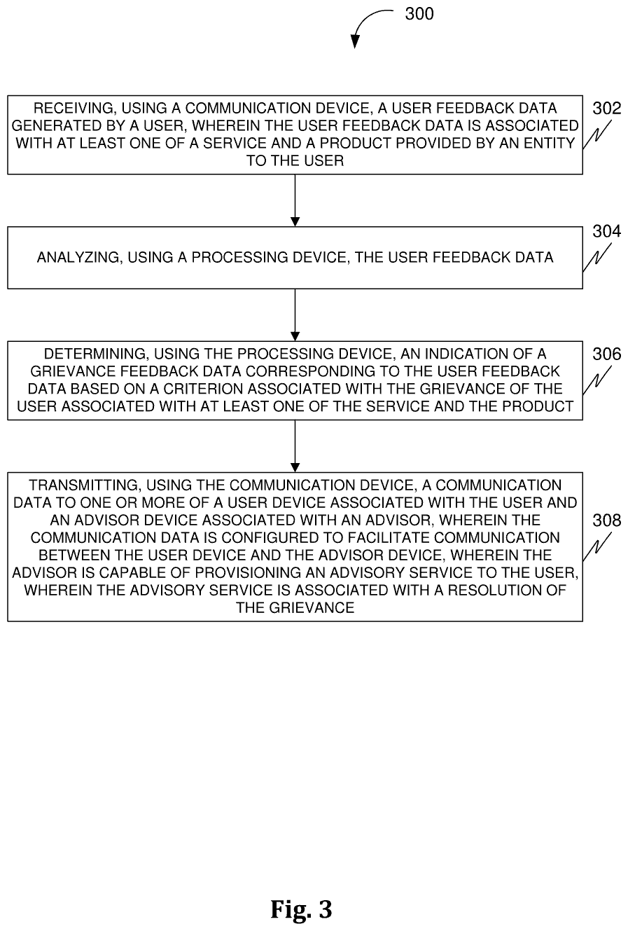

FIG. 3 illustrates a flowchart of a method 300 of facilitating provisioning of an aid corresponding to a grievance of a user, in accordance with some embodiments.

Accordingly, the method 300 may include a step 302 of receiving, using a communication device 602, a user feedback data generated by a user.

In some embodiments, the communication device 602 may be an electronic device which may be configured to one or more of transmit and receive a data. In some embodiments, the one or more of the transmitting and the receiving of the data may be performed wirelessly.

Further, the user feedback data may be associated with one or more of a service and a product provided by an entity to the user.

In some embodiments, the user feedback data includes one or more of a user review, a user post, and a user rating associated with one or more of the service and the product. In some embodiments, the service includes one or more of a financial service, a utility service, a personal service, and a business service. In some embodiments, the product includes a tangible product in possession of the user. Further, the tangible product may be provided by the entity. In some embodiments, the entity includes one or more of a financial service provider, a person, and a utility service provider.

Further, the method 300 may include a step 304 of analyzing, using a processing device 604, the user feedback data.

In some embodiments, the processing device 604 may be an electronic device which may be configured to execute a set of instructions. In some embodiments, the analyzing of the user feedback data may be based on a machine learning model. In some embodiments, the machine learning model includes one or more of a supervised learning model, an unsupervised learning model, and a reinforcement learning model.

Further, the method 300 may include a step 306 of determining, using the processing device 604, an indication of a grievance feedback data corresponding to the user feedback data based on a criterion associated with the grievance of the user associated with one or more of the service and the product.

In some embodiments, the grievance includes a complaint of the user associated with one or more of the service and the product. In some embodiments, the method 300 may further include recognizing, using the processing device 604, one or more patterns in a training dataset comprising two or more training user feedback data and corresponding two or more indications of training grievance feedback data. Further, the determining of the indication of the grievance may be based on the pattern. In some embodiments, the entity includes a financial service provider providing an insurance service to the user. Further, the grievance associated with the insurance service includes one or more of a partial denial and a complete denial of a settlement claim associated with the insurance service. In some embodiments, the criterion includes two or more keywords associated with the grievance of the user.

Further, the method 300 may include a step 308 of transmitting, using the communication device 602, a communication data to one or more of a user device associated with the user and an advisor device associated with an advisor.

In some embodiments, the communication data includes one or more of a user contact data associated with the user device, an advisor contact data associated with the advisor device, a link data associated with a virtual meeting, and a messaging data associated with a virtual messaging application. In some embodiments, the communication data includes a communication link associated with an establishment of a communication between the user device and the advisor device. In some embodiments, each of the user device and the advisor device includes a computing device.

Further, the communication data may be configured to facilitate communication between the user device and the advisor device.

In some embodiments, facilitating provisioning of the aid includes facilitating communication between the user device and the advisor device.

Further, the advisor may be capable of provisioning an advisory service to the user.

In some embodiments, the advisor includes one or more of an adjustor, a law practitioner and an engineer. Further, the adjustor may be capable of provisioning the advisory service associated with a financial service provider. Further, the law practitioner may be capable of provisioning the advisory service associated with a law. Further, the engineer may be capable of provisioning the advisory service associated with a technology.

Further, the advisory service may be associated with a resolution of the grievance.

In some embodiments, the advisory service includes provisioning of guidance associated with the resolution of the grievance to the user.

In some embodiments, the method 300 may include transmitting, using the communication device 602, a search query to an information provider system.

In some embodiments, the search query includes two or more search keywords associated with one or more of the service, the product, and the entity. In some embodiments, the information provider system includes one or more of a search engine platform, a social media platform, a review platform, and a web platform. Further, the web platform may be associated with the entity. In some embodiments, the information provider includes two or more information databases which may be configured to store the user feedback data.

Further, the search query may be configured to retrieve the user feedback data. Further, the information provider system may be configured to execute the search query. Further, the information provider system may be configured for retrieving the user feedback data based on the execution of the search query. Further, the information provider system may be further configured for transmitting the user feedback data to the communication device 602.

In some embodiments, the method 300 may include communicating, using the communication device 602, with an advisor device comprising an advisor processing device 604 which may be configured to execute instructions corresponding to an application. Further, the advisor device may be further configured to present an advisor interface which may be configured to receive one or more advisor characteristic data associated with the advisor.

In some embodiments, the one or more advisor characteristic data includes one or more of a personal data associated with the advisor, a qualification data of the advisor, an experience data of the advisor and a contact data associated with the advisor.

Further, the transmitting of the communication data may be based on the advisor characteristic data.

In some embodiments, the method 300 may include analyzing, using the processing device 604, the advisor characteristic data. Further, the transmitting of the communication data may be based on the analyzing.

In some embodiments, the user feedback data includes a parameter associated with one or more of the service and the product. Further, the criterion includes a threshold corresponding to the parameter.

In some embodiments, the method 300 may include transmitting, using the communication device 602, the grievance feedback data to the advisor device.

In some embodiments, the method 300 may include determining, using the processing device 604, a probability of successful resolution of the grievance. Further, the transmitting of the communication data may be based on the probability of successful resolution.

In some embodiments, the method 300 may include determining, using the processing device 604, a monetary parameter associated with a successful resolution of the grievance. Further, the transmitting of the communication data may be based on the monetary parameter.

Further, in some embodiments, the method 300 may include determining, using the processing device 604, an entity contact data associated with the entity associated with the user feedback data. Further, in some embodiments, the method 300 may include transmitting, using the communication device 602, the entity contact data to the advisor device.

In some embodiments, the method 300 may include determining, using the processing device 604, a type of grievance associated with the user.

In some embodiments, the type of grievance may be associated with an indication of a specialization of the advisor. Further, the specialization of the advisor includes a financial specialization, a technological specialization, and a law specialization.

Further, the transmitting of the communication data may be based on the type of grievance.

In some embodiments, the method 300 may include transmitting, using the communication device 602, a search command to a public database. Further, the public database may be configured for executing the search command. Further, the public database may be configured to retrieve the user feedback data based on executing the search command. Further, the public database may be configured to transmit the user feedback data.

Further, in some embodiments, the method 300 may include communicating, using the communication device 602, with a user device. Further, the user device includes a user processing device which may be configured to execute an instruction corresponding to an application. Further, the user device may be configured to present a user interface which may be configured to receive one or more grievance data associated with the grievance of the user. Further, in some embodiments, the method 300 may include transmitting, using the communication device 602, the one or more grievance data to the advisor device.

In some embodiments, the method 300 may include transmitting, using the communication device 602, a contact search query to a contact provider system. Further, the contact search query may be configured to retrieve a contact data associated with the user. Further, the contact provider system may be configured to execute the query. Further, the contact provider system may be configured for retrieving the contact data based on the execution of the contact search query. Further, the contact provider system may be configured for transmitting the contact data to the communication device 602. Further, the transmitting of the communication data may be based on the contact data.

In some embodiments, the receiving of the user feedback data may be periodic.

In some embodiments, the method 300 may include determining, using the processing device 604, a classification of the user feedback data based on the criterion.

In some embodiments, the user feedback data may be received using a web scraping tool. Further, a web scraping tool may be configured to receive an identification keyword associated with an information provider. Further, the web scraper tool may be configured to extract the user feedback data from the information provider.

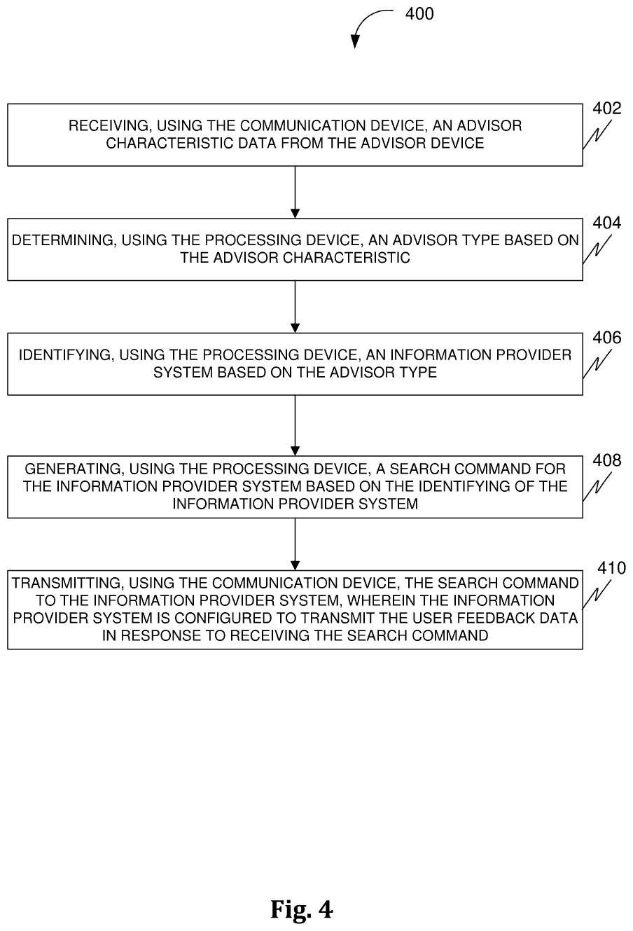

FIG. 4 illustrates a flowchart of a method 400 of facilitating provisioning of an aid corresponding to a grievance of a user including generating, using the processing device 604, a search command to the information provider system, in accordance with some embodiments.

Further, in some embodiments, the method 400 may include a step 402 of receiving, using the communication device 602, an advisor characteristic data from the advisor device. Further, in some embodiments, the method 400 may include a step 404 of determining, using the processing device 604, an advisor type based on the advisor characteristic. Further, in some embodiments, the method 400 may include a step 406 of identifying, using the processing device 604, an information provider system based on the advisor type. Further, in some embodiments, the method 400 may include a step 408 of generating, using the processing device 604, a search command for the information provider system based on the identifying of the information provider system. Further, in some embodiments, the method 400 may include a step 410 of transmitting, using the processing device 604, the search command to the information provider system. Further, the information provider system may be configured to transmit the user feedback data in response to receiving the search command.

In some embodiments, the determining of the advisor type may be based on a machine learning model.

In some embodiments, the generating of the search command may be based on the advisor type.

In some embodiments, the method 400 may include transmitting, using the communication device 602, a request to the advisor device. Further, the advisor characteristic data may be received in response to the request.

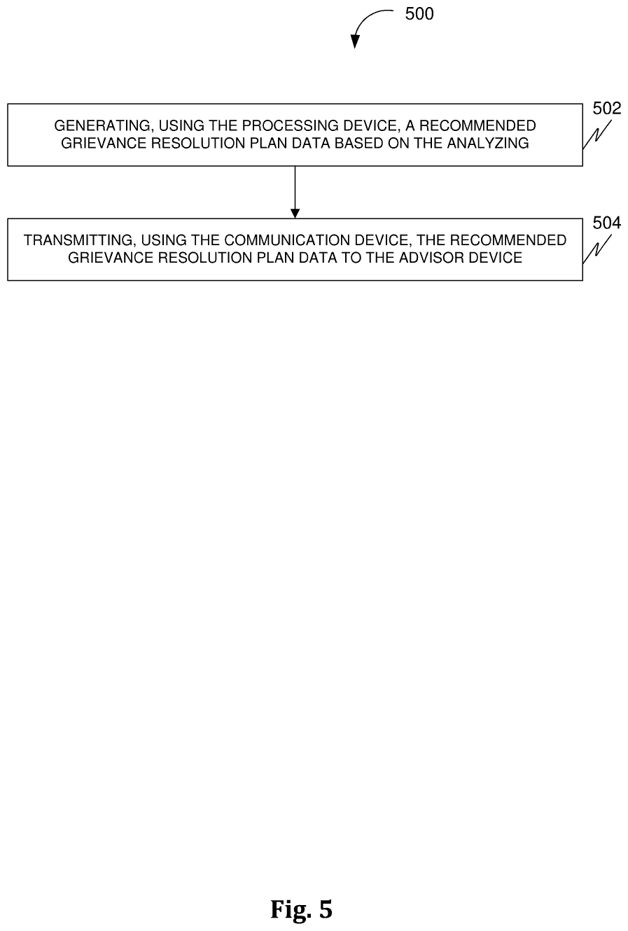

FIG. 5 illustrates a flowchart of a method 500 of facilitating provisioning of an aid corresponding to a grievance of a user including generating, using the processing device 604, a recommended grievance resolution plan data, in accordance with some embodiments.

Further, in some embodiments, the method 500 may include a step 502 of generating, using the processing device 604, a recommended grievance resolution plan data based on the analyzing. Further, in some embodiments, the method 500 may include a step 504 of transmitting, using the communication device 602, the recommended grievance resolution plan data to the advisor device.

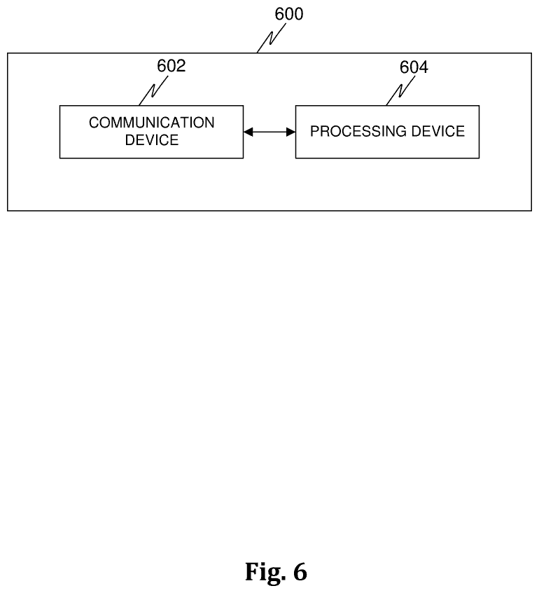

FIG. 6 illustrates a block diagram of the system 600 of facilitating provisioning of an aid corresponding to a grievance of a user, in accordance with some embodiments.

Accordingly, the system 600 may include a communication device 602. Further, the communication device 602 may be configured to receive a user feedback data generated by the user. Further, the user feedback data may be associated with one or more of a service and a product provided by an entity. Further, the communication device 602 may be configured to transmit a communication data to one or more of a user device associated with the user and an advisor device associated with an advisor. Further, the communication data may be configured to facilitate communication between the user device and the advisor device. Further, the advisor may be capable of provisioning an advisory service to the user. Further, the advisory service may be associated with a resolution of the grievance. Further, the system 600 may include a processing device 604 communicatively coupled with the communication device 602. Further, the processing device 604 may be configured to analyze the user feedback data. Further, the processing device 604 may be configured to determine an indication of a grievance feedback data corresponding to the user feedback data based on a criterion associated with the grievance of the user associated with one or more of the service and the product. Further, the transmitting may be based on determination of the indication of the grievance feedback data.

In some embodiments, the communication device 602 may be configured to transmit a search query to an information provider system. Further, the search query may be configured to retrieve the user feedback data. Further, the information provider system may be configured to execute the search query. Further, the information provider system may be configured for retrieving the user feedback data based on the execution of the search query. Further, the information provider system may be configured for transmitting the user feedback data to the communication device 602.

In some embodiments, the communication device 602 may be configured to communicate with an advisor device comprising an advisor processing device which may be configured to execute instructions corresponding to an application. Further, the advisor device may be configured to present an advisor interface which may be configured to receive an advisor characteristic data associated with the advisor. Further, the transmitting of the communication data may be based on the advisor characteristic data.

In some embodiments, the processing device 604 may be configured to analyze the advisor characteristic data. Further, the transmitting of the communication data may be based on the analyzing.

In some embodiments, the user feedback data includes a parameter associated with at least of the service and the product. Further, the criterion includes a threshold corresponding to the parameter.

In some embodiments, the communication device 602 may be configured to transmit the grievance feedback data to the advisor device

Further, in some embodiments, the communication device 602 may be configured to receive an advisor characteristic data from the advisor device. Further, the processing device 604 may be configured to determine an advisor type based on the advisor characteristic. Further, the processing device 604 may be configured to identify an information provider system based on the advisor type. Further, the processing device 604 may be configured to generate a search command to the information provider system. Further, the information provider system may be configured to transmit the user feedback data in response to receiving the search command.

In some embodiments, the processing device 604 may be configured to determine a probability of successful resolution of the grievance. Further, the transmitting of the communication data may be based on the probability of successful resolution.

In some embodiments, the processing device 604 may be configured to determine a monetary parameter associated with a successful resolution of the grievance. Further, the transmitting of the communication data may be based on the monetary parameter.

In some embodiments, the processing device 604 may be configured to generate a recommended grievance resolution plan data based on the analysis. Further, the communication device 602 may be configured to transmit the recommended grievance plan data to the advisor device.

Although the invention has been explained in relation to its preferred embodiment, it is to be understood that many other possible modifications and variations can be made without departing from the spirit and scope of the invention as hereinafter claimed.

1. A computer-implemented method of facilitating provisioning of an aid corresponding to a grievance of a user, the method comprising:
receiving, using a communication device, a user feedback data generated by a user, wherein the user feedback data is associated with at least one of a service and a product provided by an entity to the user;
analyzing, using a processing device, the user feedback data;
determining, using the processing device, an indication of a grievance feedback data corresponding to the user feedback data based on a criterion associated with the grievance of the user associated with at least one of the service and the product; and
transmitting, using the communication device, a communication data to one or more of a user device associated with the user and an advisor device associated with an advisor, wherein the communication data is configured to facilitate communication between the user device and the advisor device, wherein the advisor is capable of provisioning an advisory service to the user, wherein the advisory service is associated with a resolution of the grievance.

2. The method of claim 1 further comprising transmitting, using the communication device, a search query to an information provider system, wherein the search query is configured to retrieve the user feedback data, wherein the information provider system is configured to execute the search query, wherein the information provider system is further configured for retrieving the user feedback data based on the execution of the search query, wherein the information provider system is further configured for transmitting the user feedback data to the communication device.

3. The method of claim 1 further comprising communicating, using the communication device, with an advisor device comprising an advisor processing device configured to execute instructions corresponding to an application, wherein the advisor device is further configured to present an advisor interface configured to receive at least one advisor characteristic data associated with the advisor, wherein the transmitting of the communication data is based on the advisor characteristic data.

4. The method of claim 3 further comprising analyzing, using the processing device, the advisor characteristic data, wherein the transmitting of the communication data is further based on the analyzing.

5. The method of claim 1, wherein the user feedback data comprises a parameter associated with at least one of the service and the product, wherein the criterion comprises a threshold corresponding to the parameter.

6. The method of claim 1 further comprising transmitting, using the communication device, the grievance feedback data to the advisor device.

7. The method of claim 1 further comprising:
receiving, using the communication device, an advisor characteristic data from the advisor device;
determining, using the processing device, an advisor type based on the advisor characteristic;
identifying, using the processing device, an information provider system based on the advisor type;
generating, using the processing device, a search command for the information provider system based on the identifying of the information provider system; and
transmitting, using the communication device, the search command to the information provider system, wherein the information provider system is configured to transmit the user feedback data in response to receiving the search command.

8. The method of claim 1 further comprising determining, using the processing device, a probability of successful resolution of the grievance, wherein the transmitting of the communication data is based on the probability of successful resolution.

9. The method of claim 1 further comprising determining, using the processing device, a monetary parameter associated with a successful resolution of the grievance, wherein the transmitting of the communication data is based on the monetary parameter.

10. The method of claim 1 further comprising:
generating, using the processing device, a recommended grievance resolution plan data based on the analyzing; and
transmitting, using the communication device, the recommended grievance resolution plan data to the advisor device.

11. A system for facilitating provisioning of an aid corresponding to a grievance of a user, the system comprises:
a communication device configured to:
receive a user feedback data generated by the user, wherein the user feedback data is associated with at least one of a service and a product provided by an entity; and
transmit a communication data to one or more of a user device associated with the user and an advisor device associated with an advisor, wherein the communication data is configured to facilitate communication between the user device and the advisor device, wherein the advisor is capable of provisioning an advisory service to the user, wherein the advisory service is associated with a resolution of the grievance;
a processing device communicatively coupled with the communication device wherein the processing device is configured to:
analyze the user feedback data; and
determine an indication of a grievance feedback data corresponding to the user feedback data based on a criterion associated with the grievance of the user associated with at least one of the service and the product, wherein the transmitting is based on determination of the indication of the grievance feedback data.

12. The system of claim 11, wherein the communication device is further configured to transmit a search query to an information provider system, wherein the search query is configured to retrieve the user feedback data, wherein the information provider system is configured to execute the search query, wherein the information provider system is further configured for retrieving the user feedback data based on the execution of the search query, wherein the information provider system is further configured for transmitting the user feedback data to the communication device.

13. The system of claim 11, wherein the communication device is further configured to communicate with an advisor device comprising an advisor processing device configured to execute instructions corresponding to an application, wherein the advisor device is further configured to present an advisor interface configured to receive an advisor characteristic data associated with the advisor, wherein the transmitting of the communication data is based on the advisor characteristic data.

14. The system of claim 13, wherein the processing device is further configured to analyze the advisor characteristic data, wherein the transmitting of the communication data is based on the analyzing.

15. The system of claim 11, wherein the user feedback data comprises a parameter associated with at least of the service and the product, wherein the criterion comprises a threshold corresponding to the parameter.

16. The system of claim 11, wherein the communication device is further configured to transmit the grievance feedback data to the advisor device

17. The system of claim 11, wherein the communication device is further configured to receive an advisor characteristic data from the advisor device, wherein the processing device is further configured to:
determine an advisor type based on the advisor characteristic;
identify an information provider system based on the advisor type; and
generate a search command to the information provider system, wherein the information provider system is configured to transmit the user feedback data in response to receiving the search command.

18. The system of claim 11, wherein the processing device is further configured to determine a probability of successful resolution of the grievance, wherein the transmitting of the communication data is based on the probability of successful resolution.

19. The system of claim 11, wherein the processing device is further configured to determine a monetary parameter associated with a successful resolution of the grievance, wherein the transmitting of the communication data is based on the monetary parameter.

20. The system of claim 11, wherein the processing device is further configured to generate a recommended grievance resolution plan data based on the analysis, wherein the communication device is further configured to transmit the recommended grievance plan data to the advisor device.
